(19) United States
(12) Patent Application Publication
(10) Pub. No.: US 2003/0206291 A1
(43) Pub. Date: Nov. 6, 2003

(54) Optical configuration and method for differential refractive index measurements

(75) Inventors: Michael J. Byrne, East Aurora, NY (US); Keshav D. Sharma, Lancaster, NY (US); Robert C. Atkinson, Buffalo, NY (US)

Correspondence Address: SIMPSON & SIMPSON, PLLC, 5555 MAIN STREET, WILLIAMSVILLE, NY, 14221-5406, US

(73) Assignee: Leica Microsystems Inc., Depew, NY (US)

(21) Appl. No.: 10/139,268

(22) Filed: May 6, 2002

(51) Int. Cl. G01N 21/41

(52) U.S. Cl. 356/136

(57) ABSTRACT

An optical configuration for measuring a difference in refractive index between a first sample and a second sample comprises partitioned first and second optical interfaces symmetrically illuminated by an illumination beam to provide first and second partial beams defined by the refractive index of the first and second samples, respectively. First and second linear scanned arrays are positioned on opposite sides of a meridional plane of the optical configuration for respectively detecting the first and second partial beams. Thus, differential measurements are possible based on signal information from the arrays. Embodiments for critical angle and surface plasmon resonance refractive index measurements are disclosed. The disclosure also relates to methods for measuring a difference in refractive index between a first sample and a second sample in accordance with the described optical configuration embodiments.

### FIELD OF THE INVENTION

The present invention relates generally to optical instruments for measuring refractive index of a substance, and more particularly to an optical configuration for measuring a difference in refractive index between a first sample and a second sample. The present invention is applicable to differential refractometers and surface plasmon resonance (SPR) biosensor devices.

### BACKGROUND OF THE INVENTION

Refractometers measure the critical angle of total reflection by directing an obliquely incident non-collimated beam of light at a surface-to-surface boundary between a high refractive index prism and a sample to allow a portion of the light to be observed after interaction at the boundary. In transmitted light refractometers, light that is transmitted through the sample and prism is observed, while in reflected light refractometers, the light that is reflected due to total reflection at the surface-to-surface boundary is observed. In either case, an illuminated region is produced over a portion of a detection field of view, and the location of the shadow line between the illuminated region and an adjacent dark region in the detection field of view allows the sample refractive index to be deduced geometrically. Differential refractometers, for example that disclosed in U.S. Pat. No. 5,157,454, have been developed for measuring a difference in refractive index between a test sample and a known reference sample, whereby variable test conditions effecting the measurement result, such as sample temperature, illumination level, etc., can be “subtracted out” to yield a more accurate and precise measurement result. The prior art differential refractometers known to applicants involve moving parts which malfunction or wear out over time, and/or are restricted to the transmitted light variety so as to prevent measurement of samples having relatively high opacity.

Optical biosensor devices designed to analyze binding of analyte molecules to a binding layer by observing changes in internal reflection at a sensing interface are also part of the related prior art. More specifically, U.S. Pat. No. 5,313,264 to Ivarsson et al. describes an optical biosensor system that comprises a plurality of side-by-side sensing surfaces 39A-D illuminated by a streak of light 5 extending transversely across the sensing surfaces, and an anamorphic lens system 6 by which rays of light reflected from the respective sensing surfaces are imaged on corresponding columns of a two-dimensional array 7 of photosensitive elements. Accordingly, the signals from the photosensitive elements can be processed to determine a minimum reflectance associated with the resonance angle at each sensing surface. Although the system described in U.S. Pat. No. 5,313,264 avoids the use of moving parts, it is nevertheless optically complex and requires a two-dimensional array, factors that are accompanied by an increase in cost.

Finally, it is noted that one-dimensional (linear) arrays of photosensitive elements cells are commonly used in automatic refractometers designed to take non-differential readings with respect to a single test sample. Examples can be found in U.S. Pat. Nos. 4,640,616 (Michalik) and 6,172,746 (Byrne et al.). However, applicants are unaware of any critical angle optical device for differential refractive index measurements that operates using linear arrays, despite the recognized economy offered by this type of array.

### BRIEF SUMMARY OF THE INVENTION

Therefore, it is an object of the present invention to provide an optical configuration for differential refractive index measurements wherein a first sample and a second sample are illuminated by a single illuminating beam.

It is another object of the present invention to provide an optical configuration for differential refractive index measurements that does not rely on moving parts.

It is a further object of the present invention to provide an optical configuration for differential refractive index measurements wherein detected light has been reflected rather than transmitted at an optical interface of the configuration.

It is a further object of the present invention to provide an optical configuration for critical angle differential refractive index measurements wherein light interacting at first and second optical interfaces corresponding to a first sample and a second sample is detected by a pair of linear scanned arrays of photoelectric cells.

It is a further object of the present invention to provide an optical configuration for differential refractive index measurements in accordance with the objects stated above, and which operates based on surface plasmon resonance principles for use in a biosensor device.

An optical configuration formed in accordance with a first embodiment of the present invention comprises an optical path defining a meridional plane of the configuration. A high index prism in the optical path includes a sample surface divided by a partition residing in the meridional plane, such that a first sample and a second sample supported by the sample surface are located on opposite sides of the meridional plane to establish a first optical interface associated with the first sample and a second optical interface associated with the second sample. An illumination beam traveling along the optical path illuminates both optical interfaces simultaneously to provide a first partial beam defined by the refractive index of the first sample and a second partial beam defined by the refractive index of the second sample. A collecting lens substantially collimates the first and second partial beams, and a pair of linear scanned arrays is located on opposite sides of the meridional plane to respectively receive the first and second partial beams. The first partial beam exhibits a feature, such as a shadow line or resonance minimum, on one of the linear scanned arrays, while the second partial beam exhibits a similar feature on the other linear scanned array. The array locations of the exhibited features are determined by analyzing the output signals of the array cells, and are indicative of the refractive index of the first and second samples, respectively.

An alternative embodiment is an adaptation of the basic configuration in order to observe molecular interactions, particularly specific binding of analyte molecules to a binding layer, using the principles of surface plasmon resonance. More specifically, a thin metallic film is applied to a slide placed on the sample surface or directly to the sample surface, and the first sample and second sample are brought into contact with the metallic film to define first and second evanescent wave optical interfaces. In this embodiment, the locations of resonance minimums exhibited by the first and second partial beams are detected.

The present invention further encompasses methods for measuring a difference in refractive index between a first sample and a second sample based on the specified optical configurations.

### BRIEF DESCRIPTION OF THE SEVERAL VIEWS OF THE DRAWINGS

The nature and mode of operation of the present invention will now be more fully described in the following detailed description of the invention taken with the accompanying drawing figures, in which:

FIG. 1 is a perspective schematic view of an optical configuration formed in accordance with a first embodiment of the present invention;

FIG. 2 is a view taken generally along the line II-II in FIG. 1;

FIG. 3 is a side schematic view of an optical configuration formed in accordance with a second embodiment of the present invention;

FIG. 4 is a top schematic view of a sample prism of the second embodiment, illustrating a line of illumination light formed by a toric lens of the configuration;

FIG. 4A is an enlarged view of part of the sample prism illustrated in FIG. 4;

FIG. 5 is a perspective view showing an optical interface portion of an optical configuration formed in accordance with a third embodiment of the present invention relating to surface plasmon resonance; and,

FIG. 6 is a perspective view showing an optical interface portion of an optical configuration formed in accordance with a fourth embodiment of the present invention also relating to surface plasmon resonance.

### DETAILED DESCRIPTION OF THE INVENTION

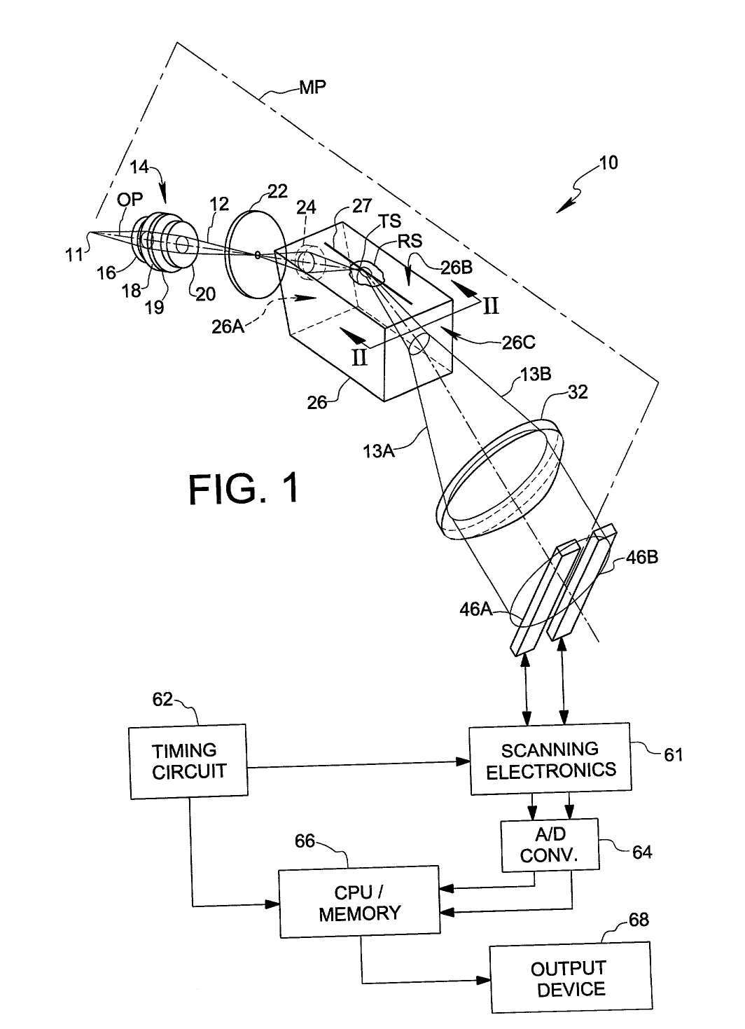

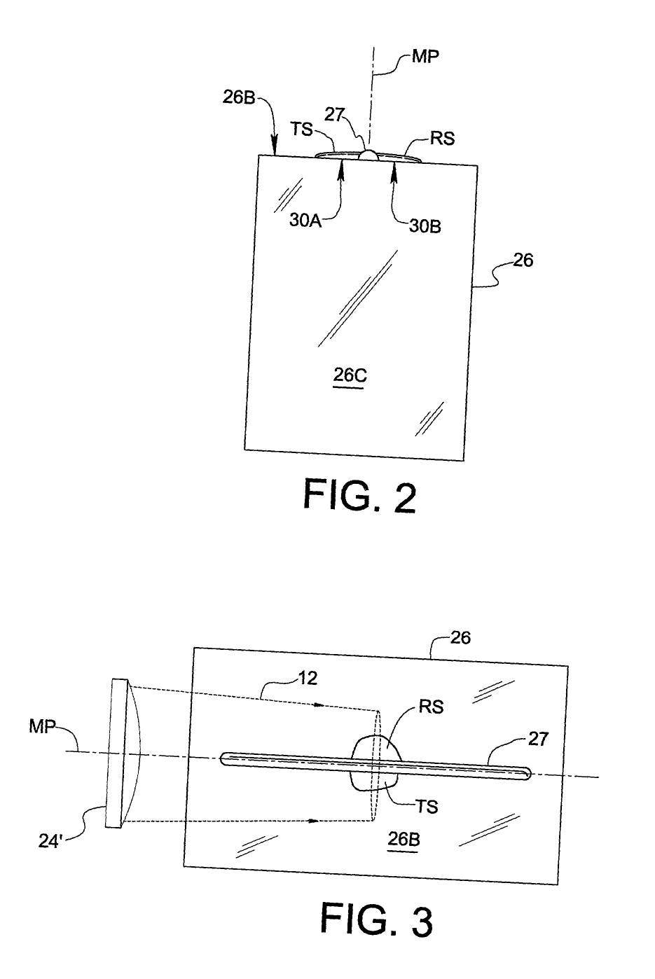

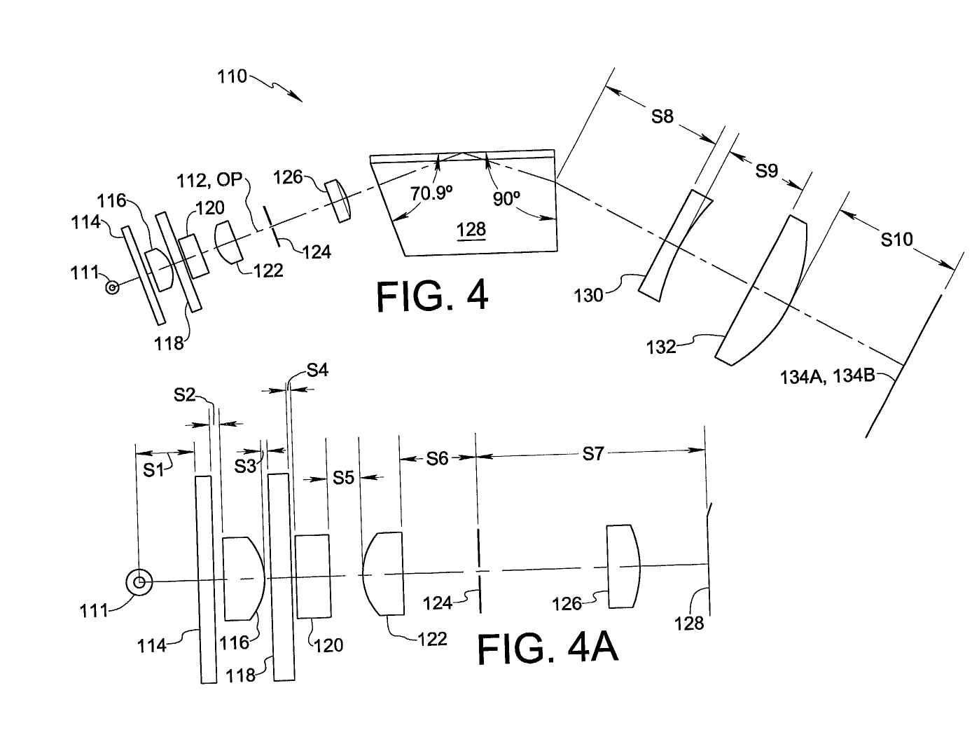

An optical configuration formed in accordance with a first embodiment of the present invention will now be described with reference to FIG. 1 of the drawings. The optical configuration of the first embodiment is shown generally at FIG. 1 and is designated by the reference numeral 10. Optical configuration 10 includes an illumination beam 12 traveling along an optical path OP from the beam's origin at a light source 11. Illumination beam 12 travels through a focusing optical system 14 preferably including a collimating lens 16, a narrow band-pass filter 18 for transmitting a narrow bandwidth of light having a central wavelength of 589 nm, a linear polarizer 19, and a focusing lens 20. The convergent illumination beam then passes through a pinhole stop 22 at the focal plane of focusing optical system 14. The divergent beam 12 is then re-focused by a positive lens 24 and enters a high refractive index prism 26, for example a sapphire prism, that includes a light entry surface 26A, a sample surface 26B contacted by test sample TS and reference sample RS, and a light exit surface 26C. Preferably, lens 24 is affixed with optical cement to light entry surface 26A of prism 26. The illuminating light is focused at a point within prism 26 just below sample surface 26B, after which point the beam once again becomes divergent. It is noted that polarizer 19 is provided to enable use of the optical configuration in connection with surface plasmon resonance measurements as will be described in a subsequent portion of this description that makes reference to FIGS. 3 and 4.

Illumination beam 12 approaches sample surface 26B as a beam of non-parallel light rays, in this instance divergent light rays, which are obliquely incident to sample surface 26B at various angles of incidence within a range of angles. Sample surface 26B is divided by a partition 27 into a first area for receiving a test sample TS and a second area for receiving a reference sample RS. Partition 27 is coplanar with optical path OP as the optical path approaches sample surface 26B such that the light rays making up illumination beam 12 are symmetrically apportioned between a first optical interface 30A associated with the test sample TS and a second optical interface 30B associated with the reference sample RS. Partition 27 is chosen to provide a fluid seal between test sample TS and reference sample RS to prevent the samples from mixing. A synthetic rubber material, for example room temperature vulcanizing (RTV) silicon rubber or VITON® synthetic rubber composition, will provide a suitable barrier.

In the present embodiment, first optical interface 30A and second optical interface 30B are critical angle optical interfaces respectively defined by the contact area of test sample TS with sample surface 26B and by the contact area of reference sample RS with sample surface 26B. These contact areas can be established by dropping the test sample TS and reference sample RS onto sample surface 26B on opposite sides of partition 27, by using a flow cell designed to bring test sample TS and reference sample RS into contact with sample surface 26B on opposite sides of partition 27, or by otherwise applying test sample TS and reference sample RS to the respective areas of sample surface 26B. The portion of illumination beam 12 reaching first optical interface 30A will interact at such interface in accordance with Snell's Law, whereby rays incident at an angle greater than or equal to the critical angle will be totally internally reflected from sample surface 26B, and rays incident at an angle less than the critical angle will be refracted and transmitted through the test sample and out of the optical system. Accordingly, the internally reflected light forms a first partial beam 13A that is defined by the index of refraction of test sample TS. A similar interaction occurs for the portion of illumination beam 12 reaching second optical interface 30B, whereby internally reflected light forms a second partial beam 13B that is defined by the index of refraction of reference sample RS. First partial beam 13A and second partial beam 13B then pass through exit surface 26C and continue through a collecting lens 32 for converting the divergent light rays to parallel light rays.

A first linear scanned array 46A and a second linear scanned array 46B are arranged side-by-side on opposite sides of meridional plane MP for receiving first partial beam 13A and second partial beam 13B, respectively. Linear scanned arrays 46A and 46B each comprise a plurality of photoelectric cells that provide an output pulse during a scan having an amplitude determined by the amount of illumination of the corresponding cell by incident light. The timing and frequency at which scanning electronics 61 scans linear arrays 46A and 46B is controlled by a timing circuit 62. The signal information provided by first linear scanned array 46A is preferably summed over a plurality of scans, and signal information from second linear scanned array 46B is preferably summed in the same manner.

As is well understood in the art of critical angle refractometry, first partial beam 13A will exhibit a shadowline at a location on first linear scanned array 46A that is indicative of the refractive index of test sample TS. In similar fashion, second partial beam 13B will exhibit a shadowline on second linear scanned array 46B that is indicative of the refractive index of reference sample RS. For example, when test sample TS and reference sample RS have the same index of refraction, their respective shadow lines will appear at the same cell-crossing location on linear scanned arrays 46A and 46B. Consequently, the difference in cell-crossing location between the test sample and reference sample shadow lines on linear scanned arrays 46A and 46B provides an indication of the difference in refractive index between the test sample and reference sample. If the refractive index of the reference sample RS is known for the particular test conditions, the refractive index of the test sample TS can be calculated from the measured difference in shadow line locations.

It is noted here that various algorithms are available for determining shadowline location on a linear scanned array, as taught for example by U.S. Pat. Nos. 4,640,616; 5,617,201; and 6,172,746; and by commonly-owned U.S. patent application Ser. No, 09/794,991 filed Feb. 27, 2001, each of these documents being hereby incorporated by reference in the present specification. The analog pulse signals from the cells of linear scanned arrays 46A and 46B are digitized by an analog-to-digital converter 64, and the digitized array information is processed by a central processing unit 66. An output device 68, such as a display monitor, printer, or other reporting device, is linked to CPU 66 for reporting measurement results in a desired format. For example, reporting can be in a non-differential mode

FIG. 3 illustrates an optical configuration formed in accordance with a second embodiment of the present invention and identified by reference numeral 110. Optical configuration 110 is generally similar to optical configuration 10 of the first embodiment. However, in the second embodiment, illumination beam 12 is refracted by a toric lens 124 before it enters prism 26. Toric lens 124 has a minimum power along a transverse meridian (a line normal to meridional plane MP) and a maximum power in a perpendicular meridian. As a result, illumination beam 12 reaches test sample TS and reference sample RS as a well-defined line of light bridging across meridional plane MP, as illustrated in FIGS. 4 and 4A. Optical configuration 110 of the second embodiment also differs from optical configuration 10 of the first embodiment in that it uses a conditioning lens system after prism 26 sequentially comprising a negative lens 130 and a positive lens 132 to provide approximately collimated light that is scaled to fit linear scanned arrays 46A and 46B.

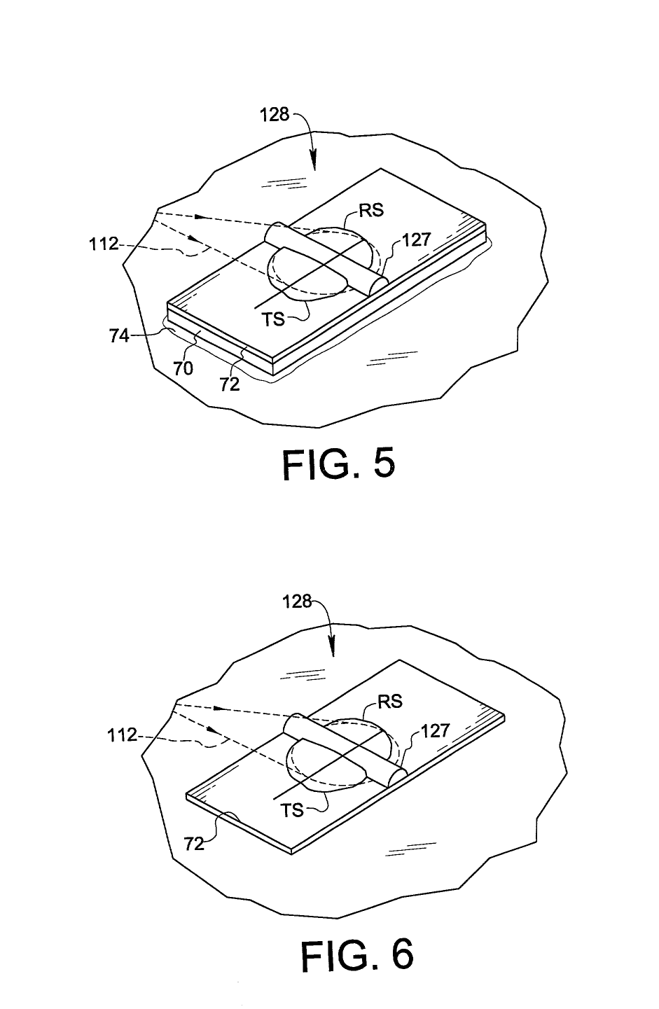

It will be recognized that the basic optical arrangements of FIGS. 1 and 3 can be used in connection with evanescent wave optical interfaces rather than critical angle optical interfaces by coupling a glass slide having a thin metallic film to sample surface 26B, or by directly coating sample surface 26B with a thin metallic film. In the arrangement shown in FIG. 5, a glass slide 70 is provided with a thin metallic film 72 on an upwardly facing surface thereof. In the present embodiment, metallic film 72 includes a layer of chromium approximately ten angstroms thick for adherence to the glass surface of slide 70, and a gold layer approximately fifty nanometers thick. A synthetic rubber material, such as RTV silicon, VITON® synthetic rubber composition, or like material is applied to metallic film 72 to provide partition 27. Metallic film 72 is optically coupled, indirectly, to prism sample surface 26B through transparent glass slide 70 and a thin layer of transparent oil 74 provided between the underside of glass slide 70 and sample surface 26B. Of course, metallic film 72 can be optically coupled to sample surface 26B by applying the film directly to sample surface 26B, as illustrated in FIG. 6. Test sample TS and reference sample RS are contacted with metallic coating 72 on opposite sides of partition 27, such that respective first and second optical interfaces are established. As light from illumination beam 12 reaches metallic film 72 at the first optical interface, certain rays will be incident at a resonance angle determined by the refractive index of test sample TS and energy associated with such rays will be absorbed, while the remainder of the rays will be internally reflected by metallic film 72. As a result of surface plasmon resonance, first partial beam 13A exhibits a resonance minimum at a location on first linear scanned array 46A that is indicative of the refractive index of test sample TS. Likewise, second partial beam 13B will exhibit a resonance minimum at a location on second linear scanned array 46B that is indicative of the refractive index of reference sample RS. It is noted here that for surface plasmon resonance applications, a narrow band-pass filter 18 preferably transmits light having a central wavelength of 780 nm.

The embodiments of FIGS. 5 and 6 based on evanescent wave principles find useful application in the observation of molecular interactions, particularly in the analysis of specific binding of analyte molecules to a binding layer. Accordingly, prepared slides having a predetermined, application-specific binding layer applied to metallic film 72 can be produced for use with a variety of analytes.

What is claimed is:

1. An optical configuration for use in measuring a difference in refractive index between a first sample and a second sample, said optical configuration comprising:
a first optical interface associated with said first sample;
a second optical interface associated with said second sample;
an illumination beam traveling along an optical path, light from said illumination beam being incident upon said first and second optical interfaces to provide a first partial beam defined by the refractive index of said first sample and a second partial beam defined by the refractive index of said second sample; and
a first linear scanned array for receiving said first partial beam and a second linear scanned array for receiving said second partial beam, said first and second linear scanned arrays respectively comprising a plurality of photoelectric cells each providing an output pulse during a scan having an amplitude determined by the amount of illumination of the corresponding cell by incident light;
wherein said first partial beam exhibits a feature indicative of said refractive index of said first sample on said first linear scanned array and said second partial beam exhibits a feature indicative of said refractive index of said second sample on said second linear scanned array.

2. The optical configuration according to claim 1, wherein said difference in refractive index can be determined from the respective locations of said exhibited features on said first and second linear scanned arrays.

3. The optical configuration according to claim 1, wherein said optical path defines a meridional plane of said optical configuration and said first and second optical interfaces are located on opposite sides of said meridional plane.

4. The optical configuration according to claim 3, wherein said first and second linear scanned arrays are located on opposite sides of said meridional plane.

5. The optical configuration according to claim 4, wherein said first and second linear scanned arrays extend parallel to one another.

6. The optical configuration according to claim 1, wherein said first and second optical interfaces are critical angle optical interfaces, such that said first and second partial beams exhibit respective shadow lines as features on said first and second linear scanned arrays.

7. The optical configuration according to claim 1, wherein said first and second optical interfaces are evanescent wave optical interfaces, such that said first and second partial beams exhibit respective resonance minimums as features on said first and second linear scanned arrays.

8. The optical configuration according to claim 1, further comprising a toric lens in said optical path upstream of said first and second optical interfaces.

9. The optical configuration according to claim 1, wherein said first and second optical interfaces are prepared on a slide selectively movable into and out of said optical path.

10. The optical configuration according to claim 4, further comprising a prism including a light entry surface, a light exit surface, and a sample surface, said illumination beam entering said prism through said light entry surface, and said first and second partial beams exiting said prism through said light exit surface.

11. The optical configuration according to claim 10, wherein said first and second optical interfaces are formed by contacting a first area of said sample surface with said first sample and contacting a second area of said sample surface with said second sample.

12. The optical configuration according to claim 11, further comprising a partition for dividing said sample surface of said prism along said meridional plane to prevent mixing of said first sample and said second sample.

13. The optical configuration according to claim 12, wherein said partition is formed of synthetic rubber.

14. The optical configuration according to claim 10, wherein said first and second optical interfaces are formed by coupling a metal film to said sample surface, said metal film having a first area contacted by said first sample and a second area contacted by said second sample.

15. The optical configuration according to claim 14, wherein said metal film is indirectly coupled to said sample surface.

16. The optical configuration according to claim 14, wherein said metal film is directly coupled to said sample surface.

17. The optical configuration according to claim 1, further comprising a conditioning lens system in said optical path downstream of said first and second optical interfaces to adapt said first and second partial beams for respective receipt by said first and second linear scanned arrays.

18. The optical configuration according to claim 17, wherein said conditioning lens system includes a positive lens.

19. The optical configuration according to claim 18, wherein said conditioning lens system further includes a negative lens.

20. The optical configuration according to claim 1, wherein one of said first and second samples is a reference sample having a known index of refraction.

21. A method for measuring a difference in refractive index between a first sample and a second sample, said method comprising the steps of:
A) providing a transparent medium having a sample surface;
B) contacting a first area of said sample surface with a first sample and a second area of said sample surface with a second sample;
C) illuminating an interface of said transparent medium and said first sample and an interface of said transparent medium and said second sample with a beam of light having obliquely incident divergent rays to provide a first partial beam defined by the refractive index of said first sample and a second partial beam defined by the refractive index of said second sample;
D) arranging a first linear scanned array of photoelectric cells to receive said first partial beam and a second linear scanned array of photoelectric cells to receive said second partial beam;
E) determining a location of a first sample critical angle shadow line on said first linear scanned array and a location of a second sample critical angle shadow line on said second linear scanned array;
F) calculating said difference in refractive index based on said shadow line locations determined in said step (E).

22. The method according to claim 21, wherein said beam of light is refracted by a toric lens before said beam of light illuminates said interfaces in said step (C).

23. The method according to claim 21, wherein one of said first and second samples is a reference sample having a known index of refraction.

24. A method for measuring a difference in refractive index between a first sample and a second sample, said method comprising the steps of:
A) providing a transparent medium having a metal film adhered thereto;
B) contacting a first area of said metal film with a first sample and a second area of said metal film with a second sample;
C) illuminating an interface of said transparent medium and said metal film with a beam of light having divergent rays obliquely incident to said interface, said beam of light simultaneously irradiating said interface at a first region opposite said first area and a second region opposite said second area to provide a first partial beam defined by the refractive index of said first sample and a second partial beam defined by the refractive index of said second sample;
D) arranging a first linear scanned array of photoelectric cells to receive said first partial beam and a second linear scanned array of photoelectric cells to receive said second partial beam;
E) determining a location of a resonance induced flux minimum associated with said first sample on said first linear scanned array and a location of a resonance induced flux minimum associated with said second sample on said second linear scanned array; and
F) calculating said difference in refractive index based on said locations of said flux minimums determined in said step (E).

25. The method according to claim 24, wherein said beam of light is refracted by a toric lens before said beam of light illuminates said interfaces in said step (C).

26. The method according to claim 24, wherein one of said first and second samples is a reference sample having a known index of refraction.
